(19) United States
(12) Patent Application Publication
(10) Pub. No.: US 2018/0238467 A1
(43) Pub. Date: Aug. 23, 2018

(54) SYSTEM AND METHODS FOR OPERATION OF A BLOWOUT PREVENTOR SYSTEM

(71) Applicant: General Electric Company, Schenectady, NY (US)

(72) Inventors: Sriram Sundar, Bangalore (IN); Shweta Gupta, Bangalore (IN); Parag Mantri, Hyderabad (IN)

(21) Appl. No.: 15/440,355

(22) Filed: Feb. 23, 2017

(51) Int. Cl. F16K 37/00; G01M 3/02; E21B 33/06; G05B 23/02

(52) U.S. Cl. CPC F16K 37/0083; G01M 3/02; G05B 23/0283; E21B 33/06; G05B 23/0267; F16K 37/0091

(57) ABSTRACT

A leak identification system for a blowout preventer (BOP) system is provided. The leak identification system includes a plurality of sensors configured to monitor one or more conditions of the BOP system and a leak detection computer device. The leak detection computer device is configured to receive at least one pressure measurement from at least one pressure sensor, receive at least one flow rate measurement from at least one flow sensor, compare the at least one pressure measurement and the at least one flow rate measurement to an algorithm, determining a leak in the BOP system based on the comparison, determine an impact to the operation of the BOP system based on the comparison and transmit the impact to the operation of the BOP system based on the comparison to a user.

### BACKGROUND

The field of the disclosure relates generally to the operation of a blowout preventer (BOP) system for oil and gas wells, and more particularly to a system and method for detecting and locating leaks in a BOP system.

Many known oil and gas production systems include a subsea blowout preventer (BOP) system that develops leaks after some time in operation, which requires service. Such leaks are mainly due to the harsh conditions under which such equipment is operated, such as high pressure, high temperature, and/or corrosive environments present proximate or within the production system.

A leak in the BOP system is one significant means of reducing operability and service life of the BOP system. This usually results in cessation of drilling operations to repair the BOP. In some cases, repair requires raising the BOP to the surface in order to find and repair the leaking component, which results in significant downtime. In many known oil and gas production systems, drillers are not able to determine a location of a subsea leak. In addition, the driller is unable to predict and quantify an impact of the leak on an operation of the system. This also prevents the drillers from deciding on a corrective course of action and therefore, increases the mean time to repair. The resulting reduction in the BOP availability has significant negative financial impact on the operation.

### BRIEF DESCRIPTION

In one aspect, a leak identification system for a blowout preventer (BOP) system is provided. The leak identification system includes a plurality of sensors configured to monitor one or more conditions of the BOP system and generate signals representing sensor data based on the one or more conditions. The plurality of sensors includes at least one pressure sensor and at least one flow sensor. The leak identification system also includes a leak detection computer device that includes a processor and a memory coupled to the processor. The leak detection computer device is in communication with the plurality of sensors. The leak detection computer device is configured to receive at least one pressure measurement from the at least one pressure sensor, receive at least one flow rate measurement from the at least one flow sensor, compare the at least one pressure measurement and the at least one flow rate measurement to an algorithm, determining a leak in the BOP system based on the comparison, determine an impact to the operation of the BOP system based on the comparison, and transmit the impact to the operation of the BOP system based on the comparison to a user.

In another aspect, a computer-based method for identifying a leak in a blowout preventer (BOP) system is provided. The method is implemented using a leak detection computer device in communication with a memory. The method includes receiving, at the leak detection computer device, at least one pressure measurement from at least one pressure sensor. The at least one pressure sensor is configured to monitor one or more pressure conditions of the BOP system and generate signals representing sensor data based on the one or more pressure conditions. The method also includes receiving, at the leak detection computer device, at least one flow rate measurement from at least one flow sensor. The at least one flow sensor is configured to monitor one or more flow conditions of the BOP system and generate signals representing sensor data based on the one or more flow conditions. The method further includes comparing, by the leak detection computer device, the at least one pressure measurement and the at least one flow rate measurement to an algorithm, determining, by the leak detection computer device, a leak in the BOP system based on the comparison, determining, by the leak detection computer device, an impact to the operation of the BOP system based on the comparison, and transmitting, from the leak detection computer device, the impact to the operation of the BOP system based on the comparison to a user.

In still another aspect, a computer-readable storage device having processor-executable instructions embodied thereon for identifying a leak in a blowout preventer (BOP) system is provided. When executed by a leak detection computer device communicatively coupled to a memory, the processor-executable instructions cause the leak detection computer device to receive at least one pressure measurement from at least one pressure sensor. The at least one pressure sensor is configured to monitor one or more pressure conditions of the BOP system and generate signals representing sensor data based on the one or more pressure conditions. The processor-executable instructions also cause the leak detection computer device to receive at least one flow rate measurement from at least one flow sensor of the plurality of sensors. The at least one flow sensor is configured to monitor one or more flow conditions of the BOP system and generate signals representing sensor data based on the one or more flow conditions. The processor-executable instructions further cause the leak detection computer device to compare the at least one pressure measurement and the at least one flow rate measurement to an algorithm, determine a leak in the BOP system based on the comparison, determine an impact on the operation of the BOP system based on the comparison, and transmit the impact on the operation of the BOP system based on the comparison to a user.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is an exemplary configuration of a sub-sea oil and gas production system including a BOP system;

FIG. 2 is a schematic view of an exemplary blowout preventer (BOP) stack, such as the subsea BOP stacks shown in FIG. 1;

FIG. 3 is a schematic view of a system for detecting and locating BOP leaks in the production system shown in FIG. 1;

FIG. 4 illustrates a multiplexed BOP control system used for with the production system shown in FIG. 1;

FIG. 5 illustrates an example configuration of a client system that may be used with the system shown in FIG. 3;

FIG. 6 illustrates an example configuration of a server system that may be used with the system shown in FIG. 3;

FIG. 7 is a schematic view of an exemplary method of operating a leak detection system using the leak detection computer device shown in FIG. 3 to detect a leak in the production system shown in FIG. 1;

FIG. 8 is an exemplary flow chart of a method to detect a leak in the production system using the leak detection computer device shown in FIG. 1;

FIG. 9 is an exemplary flow chart of a method to detect a leak in the LMRP valve branch of the production system using the leak detection computer device shown in FIG. 1;

FIG. 10 is an exemplary flow chart of a method to detect a leak in the subsea BOP branch of the production system using the leak detection computer device shown in FIG. 1; and

FIG. 11 is exemplary user interface used for displaying real-time leak detection during operation of the BOP system.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer”, and related terms, e.g., “processing device”, “computing device”, and controller” are not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include any computer program stored in memory for execution by personal computers, workstations, clients and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

The enhanced leak detection system described herein provides a method for detecting a leak in a subsea valve of a BOP (blowout preventer) in real-time using on-board sensor data and data derived from an analytical model.

Specifically, the embodiments described herein include a computing device coupled to a plurality of sensors. The computing device is configured to receive a plurality of signals containing measurement values from the plurality of sensors to detect a BOP leak. The computing device uses sensor data to determine a location of the leak using a leak detection algorithm. The computing device also quantifies an impact of the leak on the closing times of rams and annular BOPs and its impact on the performance of the system. The method works in real-time using the data from on-board sensors in conjunction with a physics-based numerical model of the system. The enhanced leak detection system enables drillers to decide on the corrective actions for a leak in a blowout preventer by detecting a leak and determining the leak location, and estimating the effect of leak in terms of delay in completion of operation. Furthermore, the enhanced leak detection system described herein is implemented using existing sensors rather than adding sensors specifically to identify a leak. The systems described herein were developed with the constraint of using existing sensors. In addition, the locations of existing sensors have not been moved to identify the location of a leak.

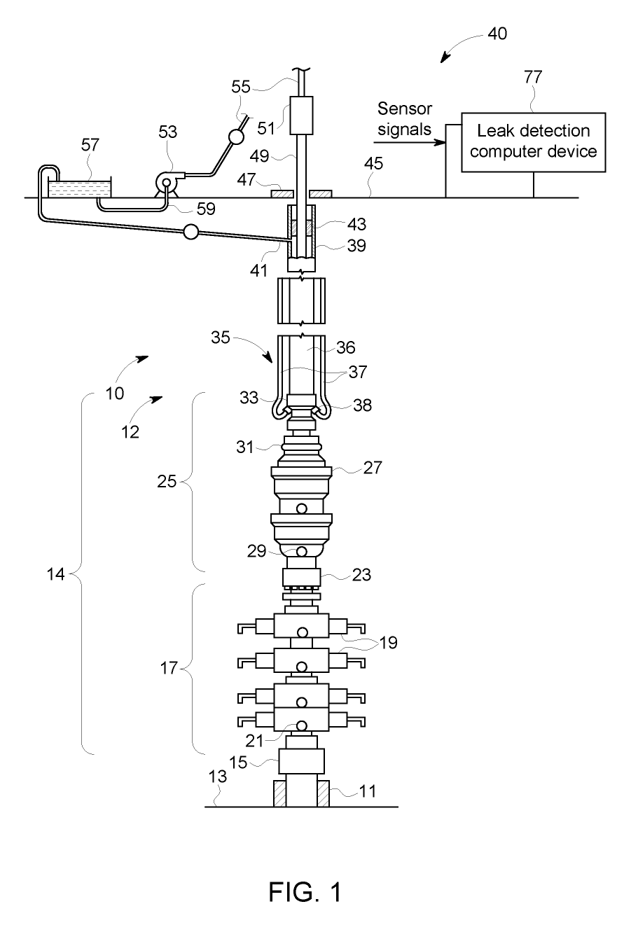

FIG. 1 is an exemplary configuration of a sub-sea oil and gas production system 10. Production system 10 includes subsea well 12 and a blowout prevention (BOP) system 14. Well 12 has a subsea wellhead assembly 11 installed at sea floor 13. At least one string of casing (not shown) is suspended in well 12 and supported by wellhead assembly 11. BOP system 14 includes a BOP stack 17 and a lower riser marine package (LMRP) 25. BOP system 14 also includes a multiplexed communications (MUX) pod (not shown). In the exemplary embodiment, leaks may occur in BOP stack 17, LMRP 25, and MUX pod.

A hydraulically actuated connector 15 releasably secures blowout preventer (BOP) stack 17 to the wellhead assembly 11. BOP stack 17 has several ram preventers, some of which are pipe rams and at least one of which is a blind shear ram. The pipe rams have cavities sized to close around and seal against pipe extending downward through wellhead assembly 11. The blind shear rams are capable of shearing the pipe and affecting a full closure. Each of the rams 19 has a port 21 located below the closure element for pumping fluid into or out of well 12 while the ram 19 is closed. The fluid flow is via choke and kill lines (not shown). Subsea BOP stack 17 may be of varying types and functions, and include several auxiliary components, such as subsea BOP stack of valves, test valve, kill and choke lines, riser joint, electrical, communication, and hydraulic lines, control pods, and a support frame.

A hydraulically actuated connector 23 couples lower riser marine package (LMRP) 25 to the upper end of BOP stack 17. Some of the elements of LMRP 25 include one or more annular BOPs 27 (two shown). Each annular BOP 27 has an elastomeric element that closes around pipes of any size. Also, annular BOP 27 can make full closure without a pipe extending through it. Each annular BOP 27 has a port 29 located below the elastomeric element for pumping fluid into or out of well 12 below the elastomeric element while annular BOP 27 is closed. The fluid flow through port 29 is handled by choke and kill lines. Annular BOPs 27 alternately could be a part of BOP stack 17, rather than being coupled to BOP stack 17 with a hydraulically actuated connector 23.

LMRP 25 includes a flex joint 31 capable of pivotal movement relative to the common axis of LMRP 25 and BOP stack 17. A hydraulically actuated riser connector 33 is mounted above flex joint 31 for connecting to the lower end of a string of riser 35. Riser 35 is made up of joints of central riser pipe 36 secured together. Auxiliary conduits 37 are spaced circumferentially around central riser pipe 36 of riser 35. Auxiliary conduits 37 are of smaller diameter than central riser pipe 36 of riser 35 and serve to communicate fluids. Some of the auxiliary conduits 37 serve as choke and kill lines. Others provide hydraulic fluid pressure. Flow ports 38 at the upper end of LMRP 25 couple certain auxiliary conduits 37 to the various actuators. When connector 33 decouples from central riser pipe 36 and riser 35 is lifted, flow ports 38 also decouples from the auxiliary conduits 37. At the upper end of riser 35, auxiliary conduits 37 are coupled to hoses (not shown) that extend to various equipment on a floating drilling vessel or platform 40.

Electrical and, optionally, fiber optic lines extend downward within an umbilical to LMRP 25. The electrical, hydraulic, and fiber optic control lines lead to one or more control modules (not shown) mounted to LMRP 25. The control module controls the various actuators of BOP stack 17 and LMRP 25.

Riser 35 is supported in tension from platform 40 by hydraulic tensioners (not shown). The tensioners allow platform 40 to move a limited distance relative to riser 35 in response to waves, wind and current. Platform 40 has equipment at its upper end for delivering upwardly flowing fluid from central riser pipe 36. This equipment may include a flow diverter 39, which has an outlet 41 leading away from central riser pipe 36 to platform 40. Diverter 39 may be mounted to platform 40 for movement with platform 40. A telescoping joint (not shown) may be located between diverter 39 and riser 35 to accommodate this movement. Diverter 39 has a hydraulically actuated seal 43 that when closed, forces all of the upward flowing fluid in central riser pipe 36 out outlet 41.

Platform 40 has a rig floor 45 with a rotary table 47 through which a pipe is lowered into riser 35 and into well 12. In this example, the pipe is illustrated as a string of drill pipe 49, but it could alternately include other well pipe, such as liner pipe or casing. Drill pipe 49 is shown coupled to a top drive 51, which supports the weight of drill pipe 49 as well as supplies torque. Top drive 51 is lifted by a set of blocks (not shown), and moves up and down a derrick while in engagement with a torque transfer rail. Alternately, drill pipe 49 could be supported by the blocks and rotated by rotary table 47 via slips (not shown) that wedge drill pipe 49 into rotating engagement with rotary table 47.

Mud pumps 53 (only one illustrated) mounted on platform 40 pump fluids down drill pipe 49. During drilling, the fluid is normally drilling mud. Mud pumps 53 are coupled to a line leading to a mud hose 55 that extends up the derrick and into the upper end of top drive 51. Mud pumps 53 draw the mud from mud tanks 57 (only one illustrated) via intake lines 59. Riser outlet 41 is coupled via a hose (not shown) to mud tanks 57. Cuttings from the earth boring occurring are separated from the drilling mud by shale shakers (not shown) before reaching mud pump intake lines 59.

Production system 10 also includes additional components as necessary to operate, such as, but not limited to, hydraulic accumulators, high pressure units (HPU), fluid reservoir units, and associated pumps, valves, hydraulic, electrical and communication lines, hydraulic connectors, and other such components for fluid control and management for subsea BOP operation.

Production system 10 includes a plurality of sensors, of which only a few are illustrated. The sensors are intended to provide an early detection of a leak, and more or fewer may be used. For reservoir evaluation and environmental reasons, monitoring of production system 10 is performed remotely. This remote monitoring requires transmission of data from the sensors in production system 10. The sensors or sensor locations are adapted to measure a parameter of interest, such as temperature, distributed temperature, pressure, acoustic energy, electric current, magnetic field, electric field, chemical properties, or a combination thereof. Such sensors include pressure gauges, temperature gauges, multi-phase flow meters, densitometers, and water cut meters. These sensors include sensors for measuring physical properties of hydraulic fluid flow, for example, measuring flow using a flow meter. The flow meter directly measures the flow rate of the hydraulic fluid.

In the exemplary embodiment, additional sensors include, but are not limited to, one or more high pressure sensors, one or more low pressure sensors, and one or more flow meters (FM). In the exemplary embodiment, LMRP 25 includes, but is not limited to, one or more flow meters (FM) and one or more high pressure sensors.

In the exemplary embodiment, the plurality of sensors are connected to a leak detection computer device 77. Leak detection computer device 77 on platform 40 receives signals from the plurality of sensors. As described herein, leak detection computer device 77 processes these signals to detect whether a leak is occurring and issues alerts and/or control signals in response. The sensors measure one or more of a following properties of a fluid inside a pipe or any other pressure containing equipment: absolute pressure, differential pressure, and temperature. In the exemplary embodiment, the flow rate of the hydraulic fluid is directly measured by the flow rate sensors. In some other embodiments, the flow rate is determined by measuring pressure variations and/or temperature variations in certain parts of production system 10 and by identifying the flow rate that is most consistent with the measured pressure and/or temperature drop according to a model of the flow.

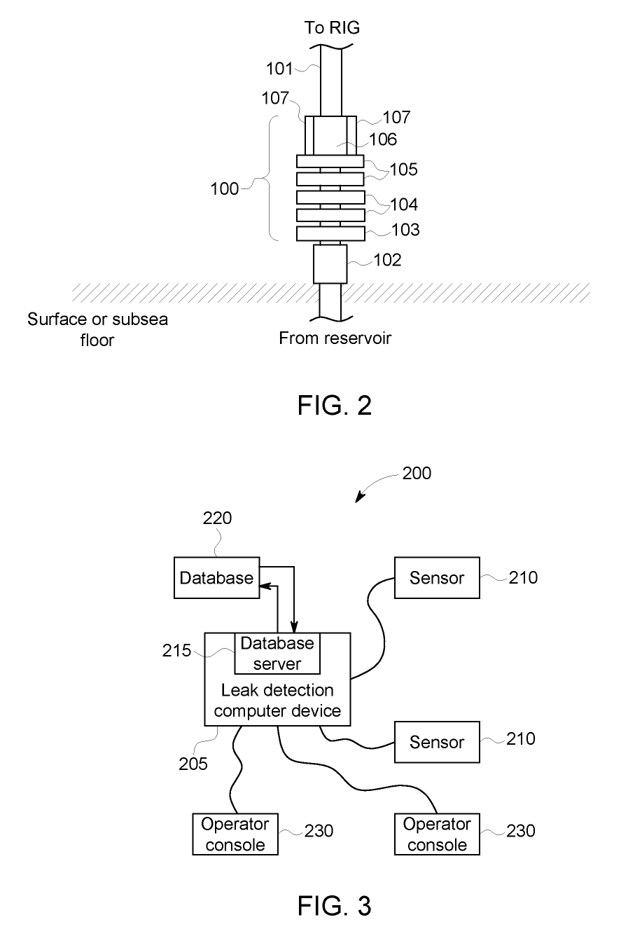

FIG. 2 is a schematic view of an exemplary blowout preventer (BOP) stack 100, such as subsea BOP stacks 17 (shown in FIG. 1). BOP stack 100 surrounds a drill pipe 101 and mounts on top of a wellhead connector 102 that includes both a wellhead and a tree (not shown). BOP stack 100 includes a test ram 103, a plurality of variable bore rams 104, a plurality of shear rams 105, a plurality of annular BOPs 106, and a plurality of control pods 107.

FIG. 3 is a schematic view of a system 200 for detecting and locating BOP leaks in production system 10 (shown in FIG. 1). In the exemplary embodiment, system 200 is used for detecting a BOP leak, determining a location of the BOP leak, determining an impact of the BOP leak, and providing a recommendation. A plurality of sensors 210 are in communication with a leak detection computer device 205, similar to leak detection computer device 77 shown in FIG. 1). Sensors 210 connect to leak detection computer device 205 through many interfaces including without limitation a network, such as a local area network (LAN) or a wide area network (WAN), dial-in-connections, cable modems, Internet connection, wireless, direct wired connections, and special high-speed Integrated Services Digital Network (ISDN) lines. Sensors 210 receive data about conditions of production system 10 and report those conditions to leak detection computer device 205.

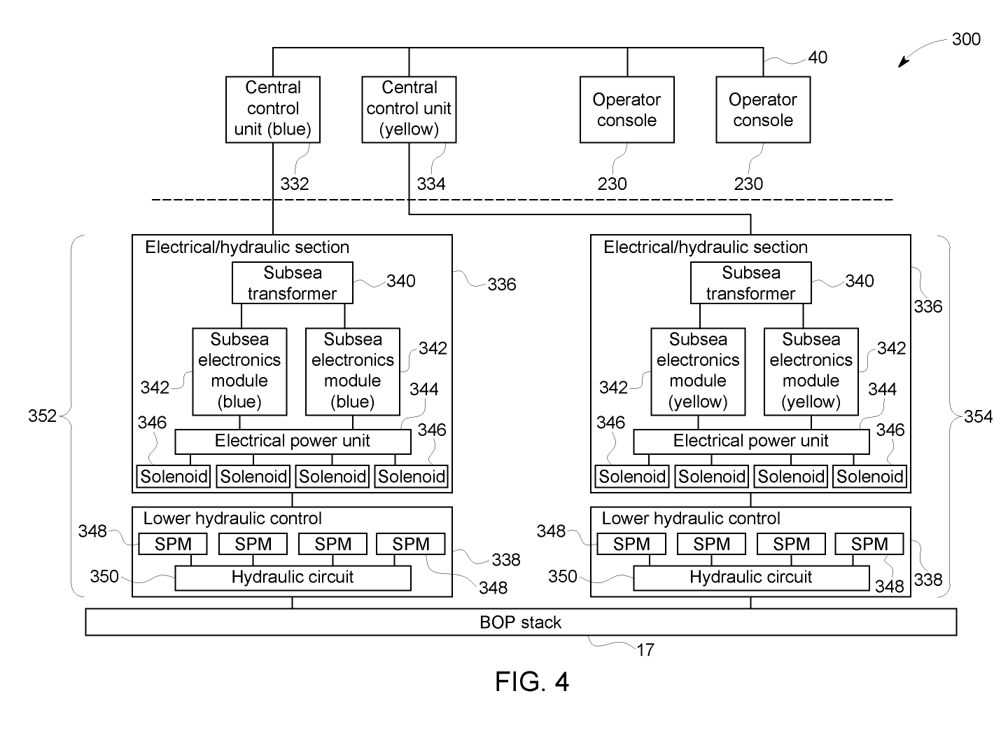

Leak detection computer device 205 is in communication with operator consoles 230. In the exemplary embodiment, operator consoles 230 are computing devices configured to provide data to and receive commands from users. In the exemplary embodiment, operator consoles 230 control one or more central control units 332 and 334 (shown in FIG. 4). Operator consoles 230 connect to leak detection computer device 205 and central control units 332 and 334 through many interfaces including without limitation a network, such as a local area network (LAN) or a wide area network (WAN), dial-in-connections, cable modems, Internet connection, wireless, and special high-speed Integrated Services Digital Network (ISDN) lines.

Sensors 210 are adapted to measure a parameter of interest, such as temperature, distributed temperature, pressure, acoustic energy, electric current, magnetic field, electric field, chemical properties, or a combination thereof. Such sensors 210 include pressure gauges, temperature gauges, multi-phase flow meters, densitometers, and water cut meters. Sensors 210 may be adapted for measuring physical properties of hydraulic fluid flow, for example, measuring flow using a flow meter. In the exemplary embodiment, the flow meter directly measures the flow rate of the hydraulic fluid. Sensors 210 connect to leak detection computer device 205 through many interfaces including without limitation a network, such as a local area network (LAN) or a wide area network (WAN), dial-in-connections, cable modems, Internet connection, wireless, and special high-speed Integrated Services Digital Network (ISDN) lines. Sensors 210 receive data about conditions of production system 10 and report those conditions at least to leak detection computer device 205. In some embodiments, sensors 210 are also in communication with other computer systems, such as, but not limited to, operator consoles 230 and central control units 332 and 334.

A database server 215 is coupled to database 220, which contains information on a variety of matters, as described below in greater detail. In one embodiment, centralized database 220 is stored on leak detection computer device 205. In an alternative embodiment, database 220 is stored remotely from leak detection computer device 205 and may be non-centralized. In some embodiments, database 220 includes a single database having separated sections or partitions or in other embodiments, database 220 includes multiple databases, each being separate from each other. Database 220 stores condition data received from multiple sensors 210. In addition, database 220 stores reference data, look-up tables, algorithms, sensor data, analysis rules, and historical data generated as part of collecting condition data from multiple sensors 210.

FIG. 4 illustrates a multiplexed BOP control system 300 used with production system 10 (shown in FIG. 1). In the exemplary embodiment, platform 40 includes at least two identical computer implemented central control units (CCUs) 332 and 334. CCU 332 is designated as a blue system and CCU 334 is designated as a yellow system. In some embodiments, there are more control units for redundancy.

CCU 332 is in communication with a blue pod 352 and CCU 334 is in communication with a yellow pod 354. Each pod 352 and 354 includes a subsea electrical and hydraulic section 336 and lower hydraulic control 338. Each electrical and hydraulic section 336 typically includes a subsea transformer 340, a pair of subsea electronics modules (SEM) 342, an electrical power unit 344, and a plurality of solenoids 346, with appropriate electrical connections. Electrical and hydraulic section 336 is coupled to lower hydraulic control section 338. Lower hydraulic control section 338 includes a plurality of SPM (sub plate mounted) valves 348 and a hydraulic circuit 350 that connects to BOP stack 17.

CCUs 332 and 334 are connected to a number of operator consoles 230 on platform 40. CCUs 332 and 334 are also connected through a signal transmission system that comprises e.g. serial communication lines and fiber optic communication lines to blue pod 352 and yellow pod 354. When paired, blue pod 352 and yellow pod 354 provides a fully-redundant, hydraulic-only, point of distribution (POD) for control of the BOP functions.

The drilling operators use operator consoles 230 (shown in FIG. 3) to control the subsea BOP valves and receive signals from sensors in BOP system 14 (shown in FIG. 1). Operator consoles 230 are connected to CCUs 332 and 334. The operators select which of the redundant CCUs 332 and 334 at the platform and which of the redundant SEMs 342 will be used to control BOP system 14.

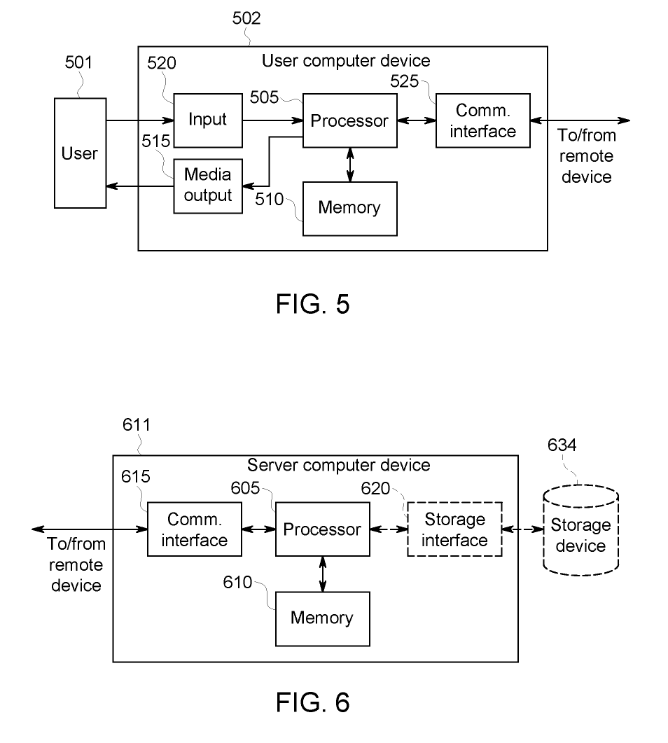

FIG. 5 illustrates an example configuration of a client system that may be used with system 200 (shown in FIG. 3). User computer device 502 is operated by a user 501. User computer device 502 may include, but is not limited to, operator consoles 230, sensors 210 (both shown in FIG. 3), and CCUs 332 and 334 (both shown in FIG. 4). User computer device 502 includes a processor 505 for executing instructions. In some embodiments, executable instructions are stored in a memory area 510. Processor 505 may include one or more processing units (e.g., in a multi-core configuration). Memory area 510 is any device allowing information such as executable instructions and/or transaction data to be stored and retrieved. Memory area 510 may include one or more computer-readable media.

User computer device 502 also includes at least one media output component 515 for presenting information to user 501. Media output component 515 is any component capable of conveying information to user 501. In some embodiments, media output component 515 includes an output adapter (not shown) such as a video adapter and/or an audio adapter. An output adapter is operatively coupled to processor 505 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 515 is configured to present a graphical user interface (e.g., a web browser and/or a client application) to user 501. A graphical user interface may include, for example, current and historical readings of various sensors 210. In some embodiments, user computer device 502 includes an input device 520 for receiving input from user 501. User 501 may use input device 520 to, without limitation, transmit commands to a linked device, such as CCUs 332 and 334. In the exemplary embodiment, input device 520 receives input from user 501 for generating control inputs for one or more components of BOP system 14. Control inputs include inputs for surface components, such as pumps and accumulators and subsea components such as rams.

Input device 520 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 515 and input device 520.

User computer device 502 may also include a communication interface 525, communicatively coupled to a remote device such as CCU 332. Communication interface 525 may include, for example, a wired or wireless network adapter and/or a wireless data transceiver for use with a mobile telecommunications network.

Stored in memory area 510 are, for example, computer-readable instructions for providing a user interface to user 501 via media output component 515 and, optionally, receiving and processing input from input device 520. The user interface may include, among other possibilities, a web browser and/or a client application. Web browsers enable users, such as user 501, to display and interact with media and other information typically embedded on a web page or a website from leak detection computer device 205. A client application allows user 501 to interact with, for example, CCU 332. For example, instructions may be stored by a cloud service and the output of the execution of the instructions sent to the media output component 515.

FIG. 6 illustrates an example configuration of a server system that may be used with system 200 (shown in FIG. 3). Server computer device 601 may include, but is not limited to, database server 215 and leak detection computer device 205 (both shown in FIG. 3). Server computer device 601 also includes a processor 605 for executing instructions. Instructions may be stored in a memory area 610. Processor 605 may include one or more processing units (e.g., in a multi-core configuration).

Processor 605 is operatively coupled to a communication interface 615 such that server computer device 601 is capable of communicating with a remote device such as another server computer device 601, operator consoles 230, sensors 210 (both shown in FIG. 3), or CCUs 332 and 334 (shown in FIG. 4). For example, communication interface 615 may receive requests from operator console 230 via the Internet.

Processor 605 may also be operatively coupled to a storage device 634. Storage device 634 is any computer-operated hardware suitable for storing and/or retrieving data, such as, but not limited to, data associated with database 220 (shown in FIG. 2). In some embodiments, storage device 634 is integrated in server computer device 601. For example, server computer device 601 may include one or more hard disk drives as storage device 634. In other embodiments, storage device 634 is external to server computer device 601 and may be accessed by a plurality of server computer devices 601. For example, storage device 634 may include a storage area network (SAN), a network attached storage (NAS) system, and/or multiple storage units such as hard disks and/or solid state disks in a redundant array of inexpensive disks (RAID) configuration.

In some embodiments, processor 605 is operatively coupled to storage device 634 via a storage interface 620. Storage interface 620 is any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 634.

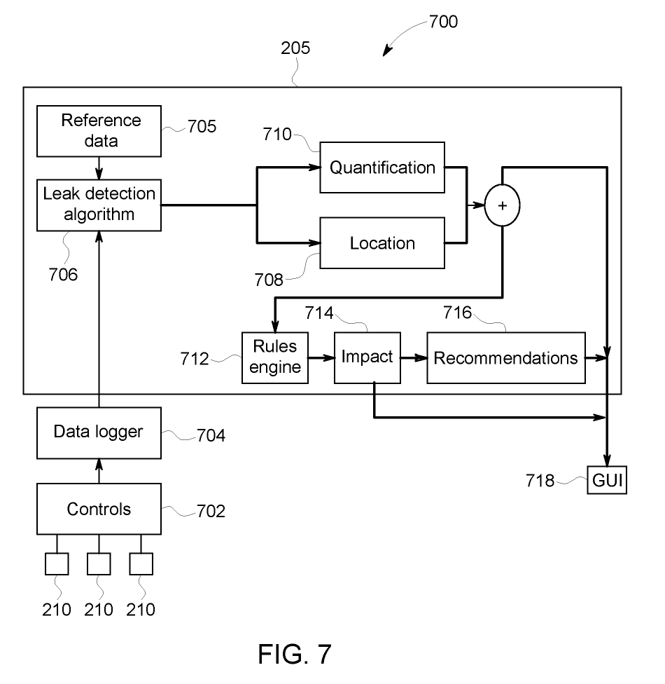

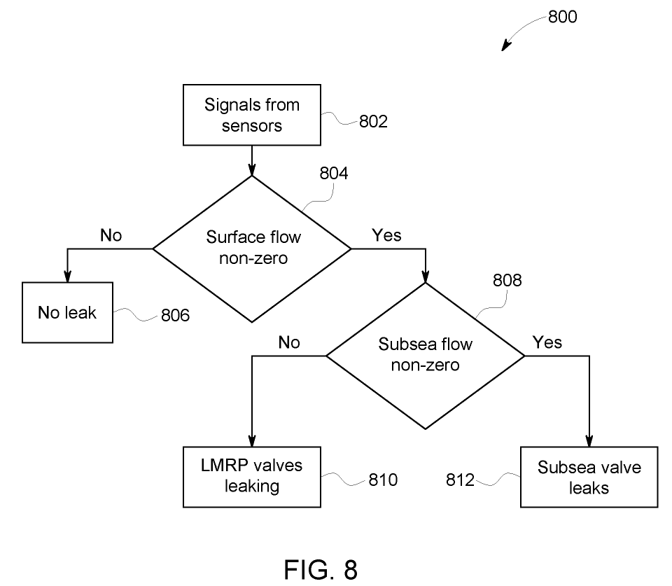

Processor 605 executes computer-executable instructions for implementing aspects of the disclosure. In some embodiments, processor 605 is transformed into a special purpose microprocessor by executing computer-executable instructions or by otherwise being programmed. For example, processor 605 is programmed with instructions such as those illustrated in FIGS. 7-10.

FIG. 7 is a schematic view of an exemplary method 700 of operating leak detection system 200 using leak detection computer device 205, (shown in FIG. 3), to detect a leak in production system 10 (shown in FIG. 1). Leak detection computer device 205 assists users with performing a corrective action for a leak in BOP system 14 (shown in FIG. 1) by detecting a leak, determining a location of the leak, and estimating an impact of the leak in terms of delay in completion of an operation. In one embodiment, leak detection computer device 205 receives sensor data from a plurality of sensors 210 (shown in FIG. 3). In some embodiments, sensors 210 transmit signals to control systems 702. Control system 702 transmits the sensor data to a data logger 704. Data logger 704 stores the received sensor data, for example in database 220 (shown in FIG. 2). Data logger 704 transmits the sensor data to leak detection computer device 205. In another embodiment, leak detection computer device 205 receives sensor data directly from sensors 210. In some embodiments, leak detection computer device 205 continually checks the sensor data readings for variations indicating leak conditions.

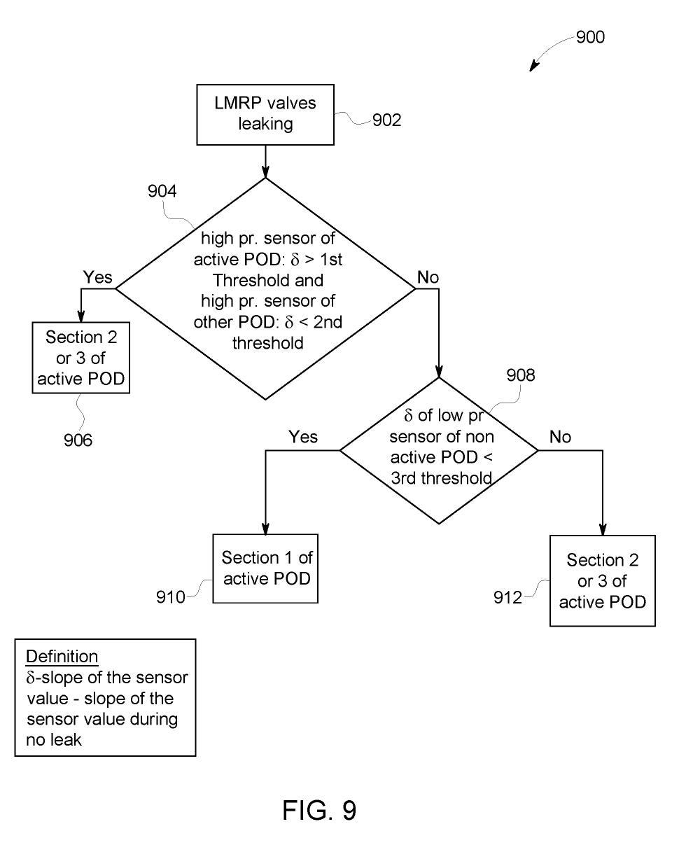

Leak detection computer device 205 uses a leak detection algorithm 706 to detect whether there is a BOP leak, as described further in FIG. 8 below. Leak detection computer device 205 defines two parameters, delta and slope of delta, from each of the sensors measurements. Delta is defined as the difference between a current measurement of a sensor and an expected measurement reference in no leak conditions. Leak detection computer device 205 uses the sensor data measurements to compare with references included in offline reference data 705. In some embodiments, offline reference data 705 is stored in database 220. The references are generated using an offline BOP Simulator (not shown) and are the results of test cases for all possible scenarios involving no leak conditions. Reference data 705 translates into sets of rules which compare the data measurements from sensors 210 with derived thresholds and make a prediction on leaks. Reference data 705 may include, but is not limited to, look-up tables, threshold values, and data from a physics based model. A leak will be detected as soon as the magnitudes of the measured pressure and flowrate signatures exceed a certain pre-determined threshold for each. If a leak condition is detected, leak detection computer device 205 uses leak detection algorithm 706 to determine a leak location 708. Using leak detection algorithm 706 to determine a leak location 708 is described in FIGS. 8-10.

In the exemplary embodiment, leak detection system 200 uses historical scenarios, second-order regression models, and physics based models to determine the linkages between sensor readings and the leak location, quantity, and impact. BOP simulator may train the models to replicate a high-quality physics based model. In other embodiments, the linkages are determined a regression or any mathematical model. In still other embodiments, the linkages may be determined based on statistical methods.

In the exemplary embodiment, leak detection algorithm 706 is based on mapping the characteristics of sensors to the leak location. The sensor characteristics are captured in real-time using the different in the absolute value with respect to the no leak value and the slope of the value with respect to the slope with no leak. Leak detection algorithm 706 and threshold values, such as those in reference data 705, is obtained from physics-based models and statistical models as described above. Furthermore, leak detection algorithm 706 is platform independent. In addition, leak detection algorithm 706 is executed in real-time.

Leak detection computer device 205 quantifies a leak rate 710 determined from the flow sensor, and a location 708 of the leak using leak detection algorithm 706. Leak detection computer device 205 then determines a real-time impact 714 of the leak by quantifying a delay in completing an operation because of the leak in BOP system 14. Leak detection computer device 205 includes a rules engine 712 that uses leak rate 710 and leak location 708 to analyze impact 714 of the leak and provide a recommendation 716 to the operator. For example, an impact estimation algorithm receives leak location and leak quantity as inputs and estimates the impact of the leak on the system performance.

Rules engine 712 uses a transfer function to estimate an impact 714 in the operation of BOP system 14. Leak rate 710 and leak location 708 serve as inputs to transfer functions to quantify the impact 714. The transfer functions are based on second order regression models that link the inputs (flow rate and location data from previous algorithm) to the outputs (for example the closing times of components, such as, but not limited to, test ram 103, variable bore rams 104, shear rams 105, annular BOPs 106 (all shown in FIG. 2), and annular BOPs 27 (shown in FIG. 1)). These second order regression models are trained to replicate high-fidelity hydraulic simulation model based on physics. Rules engine 712 determines impact 714 by inputting leak rate 710 and leak location 708 into the transfer function to obtain the difference in closing time between normal operation (no leaks) of the affected components and the operation of the affected components based on the detected leak. In the exemplary embodiment, rules engine 712 includes a second order regression model.

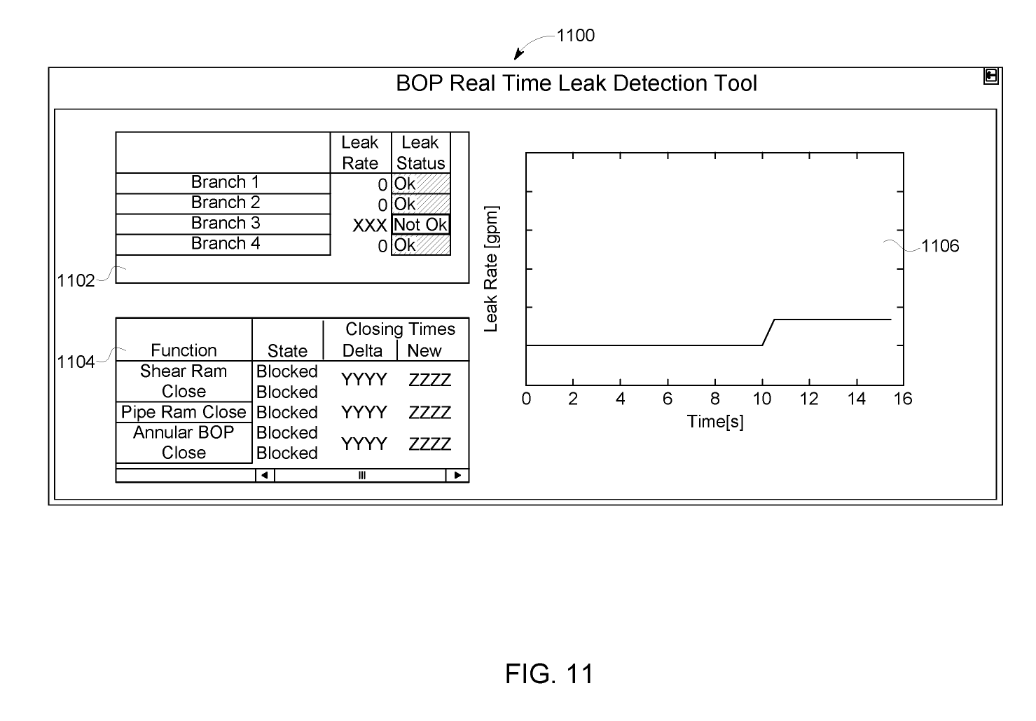

The operation of BOP system 14 is replicated on a graphical user interface 718 of a designated computing device, such as operator console 230 (shown in FIG. 3). An example of graphical user interface (GUI) 718 is similar to user interface 1100 (shown in FIG. 11). The impact 714 the leak has on BOP system 14 is displayed on graphical user interface 718 of the computing device.

Examples of recommendations include, but are not limited to, advising the operator whether to pull the stack up for maintenance or continue operating, suggesting an alternate route to perform the same function if continuing the operation via original route is not possible, and suggesting an alternate operation to achieve the same functionality in case of an emergency. Examples of impacts 714 include, but are not limited to, an increase in closing time of a ram or annular BOP and an inability to perform or complete certain operations. For example, an inability of a shear RAM to shear the pipe completely due to a lack of fluid volume/pressure available.

As shown in FIG. 7 in the exemplary embodiment, data from sensors 210 is collected by controls 702 and stored by data logger 704, potentially in database 220. The sensor data is sent to or accessed by leak detection computer device 205. Leak detection computer device 205 also accessed reference data 705. Leak detection computer device 205 uses leak detection algorithm 706 to combine sensor data and reference data 705 to determine location 708 and quantification 701 of a leak. Leak detection computer device 205 inputs the determined location 708 and quantification 701 of a leak into rules engine 712 to determine impact 714 of leak and recommendations 716. Leak detection computer device 205 transmits impact 714 and recommendations 716 to GUI 718 for display to a user.

FIGS. 8-10 illustrate an exemplary method for detecting a leak, quantifying the leak, and identifying the leak's location. In the exemplary embodiment, the method described below was generated based on the scenarios and rules generated by the offline BOP Simulator as described above. The exact branches and thresholds may vary from system to system based on the components within the system.

FIG. 8 is an exemplary flow chart 800 of a method of detecting at least one leak in BOP system 14 (shown in FIG. 1) using leak detection computer device 205 shown in FIG. 3. Leak detection computer device 205 uses the methods and algorithms described in association with FIG. 7 to detect a leak in a subsea valve of BOP stack 17 (shown in FIG. 1), the MUX pod (not shown), or lower marine riser package (LMRP) 25 (shown in FIG. 1) valves in real-time using sensor data and data derived from a leak detection algorithm 706 (shown in FIG. 7). Leak detection computer device 205 receives 802 sensor data from sensors 210 (shown in FIG. 3) to determine a location 708 (shown in FIG. 7) of the leak in a valve or in a set of valves. Leak detection computer device 205 further quantifies an impact 714 (shown in FIG. 7) of the leak on the closing times of rams and annular BOPs.

Leak detection computer device 205 initially determines 804 whether the surface flow meter is registering hydraulic fluid flow (i.e. non-zero). If leak detection computer device 205 determines 804 that the surface flow meter is not ticking, leak detection computer device 205 determines 806 that no leak is detected. Conversely, a leak is detected if leak detection computer device 205 determines that the surface flow meter is registering hydraulic fluid flow (i.e. non-zero).

Once a leak is detected, leak detection computer device 205 categorizes the leak as a subsea valve leak 812 or a lower marine riser package (LMRP) valve leak 810 to provide more detailed insight on the condition of the leaking valve and its impact on the performance of system 10. More specially, leak detection computer device 205 further narrows a location of the leak to one or more subsea valves 812 or one or more LMRP valves 810 by determining 808 whether the subsea flow meters are registering hydraulic fluid flow (i.e. non-zero). Leak detection computer device 205 determines that a LMRP valve is leaking 810 if the subsea flow meter is not ticking. Leak detection computer device 205 determines that a subsea valve is leaking 812 if the subsea flow meters are ticking.

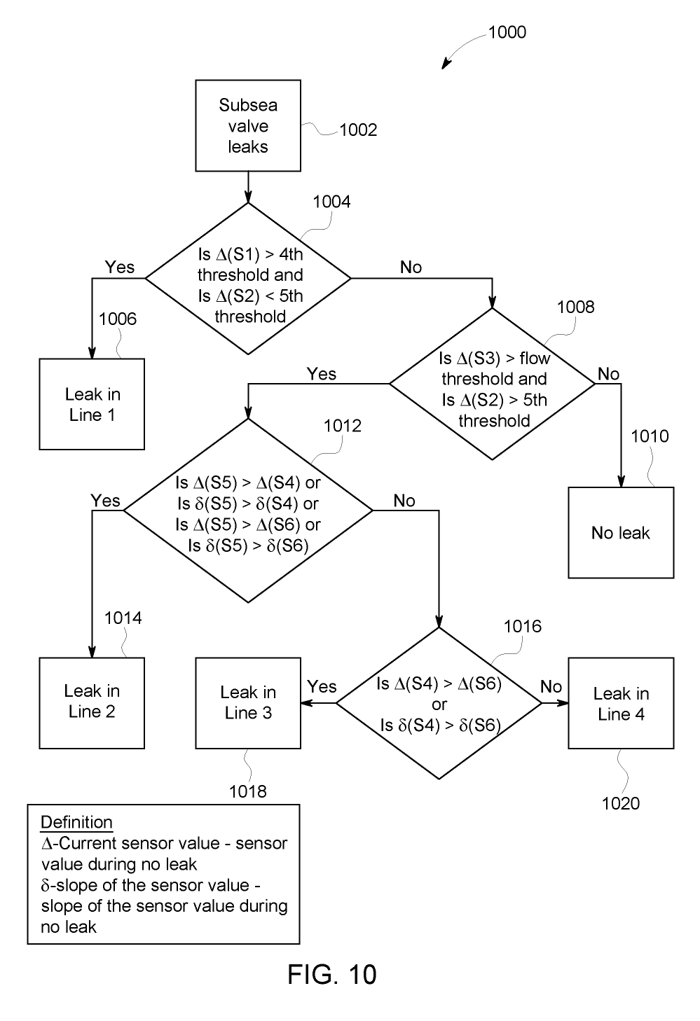

If the subsea flow meters are not ticking, leak detection computer device 205 determines that the LMRP valves are leaking 810 and proceeds to the method shown in FIG. 9. If the subsea flow meters are ticking, leak detection computer device 205 determines that the subsea valves are leaking 812 and proceeds to the method shown in FIG. 10.

FIG. 9 is an exemplary leak detection flow chart 900 of a method for identifying a leak in LMRP 25 (shown in FIG. 1) valve branch using leak detection computer device 205 (shown in FIG. 3). As described in FIG. 8, leak detection computer device 205 determines 902 that one or more LMRP valves are leaking. Leak detection computer device 205 determines 904 whether δ(high pressure sensor of the active pod) is greater than a first threshold and δ(high pressure sensor of the other pods) is less than a second threshold, where δ is a slope of an actual sensor measurement minus a predefined slope of the expected sensor measurement during no leak. For example, δ(high pressure sensor of the active pod) represents the slope (δ) of high pressure sensor of the active pod. Leak detection computer device 205 determines 906 that section 2 or section 3 of the active pod, for example, of blue pod 352 or yellow pod 354 (both shown in FIG. 4) is leaking if δ(high pressure sensor of the active pod) is greater than the first threshold and δ(high pressure sensor of the other pod(s)) is less than the second threshold. In the exemplary embodiment, the first threshold and the second threshold are based on the calculations of the BOP Simulator.

As used herein, each pod (i.e. 352 and 354) is divided up into a plurality of sections to assist in identifying the location of leaks. In some embodiments, the divisions are determined by the operator. In other embodiments, the divisions are determined by the BOP Simulator when it generates the thresholds. In the exemplary embodiment, each pod is divided into three sections. In other embodiments, the pods may be divided into more or less sections as necessary to implement the described methods.

If leak detection computer device 205 determines that δ(high pressure sensor of the active pod) is less than the first threshold and/or δ(high pressure sensor of other pods) is greater than the second threshold, leak detection computer device 205 determines 908 whether δ(low pressure sensor of the non-active pods) is less than a third threshold. Leak detection computer device 205 determines 910 that section 1 of the active pod are leaking if δ(low pressure sensor of non-active pods) is less than the third threshold. Conversely, leak detection computer device 205 determines 912 that section 2 or section 3 of active pods is leaking if δ(low pressure sensor of the non-active pods) is less than the third threshold.

In the exemplary embodiment, leak detection computer device 205 reports the location of the leak to the user through one or more operator consoles 230 (shown in FIG. 3).

FIG. 10 is an exemplary leak detection flow chart 1000 of a method for identifying a leak in a subsea BOP stack 17 (shown in FIG. 1) using leak detection computer device 205 (shown in FIG. 3). As described in FIG. 7, leak detection computer device 205 determines 1002 that a subsea valve is leaking. Leak detection computer device 205 determines 1004 whether Δ(high pressure sensor—S1) is greater than approximately a fourth threshold and whether Δ(medium pressure sensor—S2) is less than a fifth threshold, where Δ is the difference between a current measurement for a sensor and a predefined value for the sensor during no leak. For example, Δ(high pressure sensor—S1) represents the difference between a current measurement for the high pressure sensor and a predefined value for the high pressure sensor during no leak.

Leak detection computer device 205 determines 1006 there is a leak in a first line if Δ(high pressure sensor—S1) is greater than the fourth threshold and Δ(medium pressure sensor—S2) is less than the fifth threshold. Examples of lines include, but are not limited to high pressure line, manifold pressure line, lower annular line, and upper annular line. Conversely, if leak detection computer device 205 determines 1004 that Δ(high pressure sensor—S1) is less than the fourth threshold and/or Δ(medium pressure sensor—S2) is greater than the fifth threshold, leak detection computer device 205 determines 1008 whether Δ(flow meter—S3) is greater than a flow threshold and Δ(medium pressure sensor—S2) is greater than the fifth threshold. Leak detection computer device 205 determines 1010 that there is no leak if Δ(flow meter—S3) is less than the flow threshold and/or Δ(medium pressure sensor—S2) is less than the fifth threshold.

If leak detection computer device 205 determines 1008 that Δ(flow meter—S3) is greater than the flow threshold and Δ(medium pressure sensor—S2) is greater than fifth threshold, leak detection computer device 205 determines 1012 whether Δ(second line pressure sensor—S5) is greater than Δ(third line pressure sensor—S4) or δ(second line pressure sensor—S5) is greater than δ(third line pressure sensor—S4) or Δ(second line pressure sensor—S5) is greater than Δ(fourth line pressure sensor—S6) or δ(second line pressure sensor—S5) is greater than δ(fourth line pressure sensor—S6). Leak detection computer device 205 determines 1014 there is a leak in the second line if Δ(2nd pressure sensor) is greater than Δ(third line pressure sensor—S4), if Δ(second line pressure sensor—S5) is greater than Δ(third line pressure sensor—S4) or Δ(second line pressure sensor—S5) is greater than δ(fourth line pressure sensor—S6), or if δ(second line pressure sensor—S5) is greater than δ(fourth line pressure sensor—S6).

Conversely, if leak detection computer device 205 determines 1012 that Δ(second line pressure sensor—S5) is less than Δ(third line pressure sensor—S4), that δ(second line pressure sensor—S5) is less than δ(third line pressure sensor—S4), and that Δ(second line pressure sensor—S5) is less than Δ(fourth line pressure sensor—S6) and δ(second line pressure sensor—S5) is less than δ(fourth line pressure sensor—S6), leak detection computer device 205 determines 1016 if Δ(third line pressure sensor—S4) is greater than Δ(fourth line pressure sensor—S6) or if δ(third line pressure sensor—S4) is greater than δ(fourth line pressure sensor—S6). Leak detection computer device 205 determines 1018 that there is a leak in the third line if Δ(third line pressure sensor—S4) is greater than Δ(fourth line pressure sensor—S6) or if δ(third line pressure sensor—S4) is greater than δ(fourth line pressure sensor—S6). Leak detection computer device 205 determines 1020 there is a leak in the fourth line if Δ(third line pressure sensor—S4) is less than Δ(fourth line pressure sensor—S6) and δ(third line pressure sensor—S4) is less than δ(fourth line pressure sensor—S6).

While FIGS. 8-10 describe detecting a single leak, in some embodiments, leak detection computer device 205 is capable of detecting multiple simultaneous leaks. In some further embodiments, leak detection computer device 205 detects a first leak. After accounting for the first leak, leak detection computer device 205 analyzes the sensor data to determine if there are one or more additional leaks.

The above description is for illustration only. Different configurations of components and sensors will require different thresholds and different combinations of branches.

In the exemplary embodiment, leak detection computer device 205 reports the location of the leak to the user through one or more operator consoles 230 (shown in FIG. 3).

FIG. 11 is exemplary user interface 1100 for displaying real-time leak detection during operation of BOP system 14 (shown in FIG. 1). In the exemplary embodiment, user interface 1100 is executed by operator consoles 230 (shown in FIG. 3). In another exemplary embodiment, user interface 1100 is provided by leak detection computer device 205.

In the exemplary embodiment, user interface 1100 includes a leak status monitor window 1102, a close time monitor window 1104, and a leak rate graph 1106. Leak status monitor window 1102 displays real-time data of detected leaks in BOP system 14, such as, but not limited to, the location of the leaks, the rate of the leak in each location, and the status of those leaks. Close time monitor window 1104 displays real-time information about the close times of components in BOP system 14. Leak rate graph 1106 displays real-time and historical information about leaks. For example, in the exemplary embodiment, leak rate graph 1106 displays leak rate in gpm over time in seconds.

The above-described method and system provide for enhanced leak detection system described herein provides a method for to detect a leak in a subsea valve using the on-board sensor data and data derived from an analytical model in real-time. Specifically, the embodiments described herein include a computing device coupled to a plurality of sensors. The computing device is configured to receive a plurality of signals containing measurement values from the plurality of sensors to detect a BOP leak and determine a location of the leak using a leak detection algorithm. The enhanced leak detection system uses sparse sensor data to narrow down the location of a leak to a valve or to a set of valves. It also provides for quantification of the impact of the leak on the closing times of rams and annular BOPs and its impact on the performance of the system. The method works in real-time using the data from the limited on-board sensor in conjunction with a physics-based numerical model of the system. The enhanced leak detection system enables drillers to decide on the corrective actions for a leak in a blowout preventer by detecting the leak, narrowing down the leak location, and estimating the effect of leak in terms of delay in completion of operation. Furthermore, the enhanced leak detection system described herein is implemented using existing sensors rather than adding sensors specifically to identify a leak. The systems described herein were developed with the constraint of using existing sensors. In addition, the locations of existing sensors have not been moved to identify the location of a leak.

An exemplary technical effect of the methods, systems, and apparatus described herein includes at least one of: (a) detecting a location of a leak in BOP valves and components; (b) quantifying the leak; (c) estimating the leak's impact on an operation of a BOP; (d) increasing the BOPs availability; (e) reducing MTTR (mean time to repair); (f increasing access to equipment performance data; (g) real-time information of leaks providing input for planning repairs and maintenance; (h) reducing BOP downtime by locating leaks quickly; (i) detecting the leak location and quantifying the leak accurately without additional sensors; (j) detecting leak locations withing adding to or moving existing sensor systems; (k) improving services time; and (l) assisting the driller in decision-making about when to pull-up the stack.

Exemplary embodiments of methods, systems, and apparatus for detecting leaks in a BOP are not limited to the specific embodiments described herein, but rather, components of systems and/or steps of the methods may be utilized independently and separately from other components and/or steps described herein. For example, the methods may also be used in combination with other systems requiring in-situ recognition of unusual conditions and the associated methods of detecting leaks in a BOP, and are not limited to practice with only the systems and methods as described herein. Rather, the exemplary embodiment can be implemented and utilized in connection with many other applications, equipment, and systems that may benefit from detecting leaks.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A leak identification system for a blowout preventer (BOP) system, said leak identification system comprising:
a plurality of sensors configured to monitor one or more conditions of the BOP system and generate signals representing sensor data based on the one or more conditions, said plurality of sensors comprising at least one pressure sensor and at least one flow sensor; and
a leak detection computer device comprising a processor and a memory coupled to said processor, said leak detection computer device in communication with said plurality of sensors, said leak detection computer device configured to:
receive at least one pressure measurement from said at least one pressure sensor;
receive at least one flow rate measurement from said at least one flow sensor;
compare the at least one pressure measurement and the at least one flow rate measurement to an algorithm;
determine a leak in the BOP system based on the comparison;
determine an impact to the operation of the BOP system based on the comparison; and
transmit the determined impact to a computer device associated with a user.

2. The system in accordance with claim 1, wherein said leak detection computer device is further configured to:
determine a location of the leak in the BOP system based on the comparison; and
transmit the location of the leak to the user.

3. The system in accordance with claim 2, wherein the BOP system includes a BOP stack, a multiplexed communications (MUX) pod, and a lower riser marine package (LMRP), and wherein the location of the leak is in at least one of the BOP stack, the MUX pod, and the LMRP.

4. The system in accordance with claim 2, wherein said leak detection computer device is further configured to:
determine a rate of the leak based on the comparison; and
transmit the rate of the leak to the user.

5. The system in accordance with claim 4, wherein said leak detection computer device is further configured to estimate the impact of the leak on system performance based on the location of the leak and the rate of the leak.

6. The system in accordance with claim 1, wherein said leak detection computer device is further configured to:
derive a difference in closing time for at least one component of the BOP system based on the comparison, where the at least one component includes at least one of a ram and an annular BOP; and
transmit the difference in closing time to the user.

7. The system in accordance with claim 1, wherein the computer device associated with the user includes a Graphical User Interface (GUI), and wherein the GUI is programmed to:
receive the determined impact from said leak detection computer device; and
display the determined impact to the user.

8. The system in accordance with claim 1, wherein said leak detection computer device is further configured to:
determine at least one recommended course of action based on the comparison; and
transmit the at least one recommended course of action to the user.

9. The system in accordance with claim 1, wherein the recommended course of action includes at least one of advising the user whether to pull the BOP stack up for maintenance or continue operating, suggesting an alternate route to perform a function if continuing operation via an original route is not possible, and suggesting an alternate operation to achieve a functionality in case of an emergency.

10. A computer-based method for identifying a leak in a blowout preventer (BOP) system, said method implemented using a leak detection computer device in communication with a memory, said method comprising:
receiving, at the leak detection computer device, at least one pressure measurement from at least one pressure sensor, wherein the at least one pressure sensor is configured to monitor one or more pressure conditions of the BOP system and generate signals representing sensor data based on the one or more pressure conditions;
receiving, at the leak detection computer device, at least one flow rate measurement from at least one flow sensor, wherein the at least one flow sensor is configured to monitor one or more flow conditions of the BOP system and generate signals representing sensor data based on the one or more flow conditions;
comparing, by the leak detection computer device, the at least one pressure measurement and the at least one flow rate measurement to stored information;
determining, by the leak detection computer device, a leak in the BOP system based on the comparison;
determining, by the leak detection computer device, an impact to the operation of the BOP system based on the comparison; and
transmitting, from the leak detection computer device, the determined impact to a computer device associated with a user.

11. The method in accordance with claim 10 further comprising:
determining a location of the leak in the BOP system based on the comparison; and
transmitting the location of the leak to the user.

12. The method in accordance with claim 11, wherein the BOP system includes a BOP stack, a multiplexed communications (MUX) pod, and a lower riser marine package (LMRP), and wherein the location of the leak is in at least one of the BOP stack, the MUX pod, and the LMRP.

13. The method in accordance with claim 11 further comprising:
determining a rate of the leak based on the comparison; and
transmitting the rate of the leak to the user.

14. The method in accordance with claim 13 further comprising estimating the impact of the leak on system performance based on the location of the leak and the rate of the leak.

15. The method in accordance with claim 10 further comprising:
deriving a difference in closing time for at least one component of the BOP system based on the comparison, where the at least one component includes at least one of a ram and an annular BOP; and
transmitting the difference in closing time to the user.

16. The method in accordance with claim 10 further comprising:
determining at least one recommended course of action based on the comparison; and
transmitting the at least one recommended course of action to the user.

17. A computer-readable storage device having processor-executable instructions embodied thereon, for identifying a leak in a blowout preventer (BOP) system, wherein when executed by a leak detection computer device communicatively coupled to a memory, the processor-executable instructions cause the leak detection computer device to:
receive at least one pressure measurement from at least one pressure sensor, wherein the at least one pressure sensor is configured to monitor one or more pressure conditions of the BOP system and generate signals representing sensor data based on the one or more pressure conditions;
receive at least one flow rate measurement from at least one flow sensor of the plurality of sensors, wherein the at least one flow sensor is configured to monitor one or more flow conditions of the BOP system and generate signals representing sensor data based on the one or more flow conditions;
compare the at least one pressure measurement and the at least one flow rate measurement to a algorithm;
determine a leak in the BOP system based on the comparison;
determine an impact on the operation of the BOP system based on the comparison; and
transmit the impact on the operation of the BOP system based on the comparison to a user.

18. The computer readable storage device of claim 17, wherein the processor-executable instructions cause the leak detection computer device to:
determine a location of the leak in the BOP system based on the comparison; and
transmit the location of the leak to the user.

19. The computer readable storage device of claim 18, wherein the BOP system includes a BOP stack, a multiplexed communications (MUX) pod, and a lower riser marine package (LMRP), and wherein the location of the leak is in at least one of the BOP stack, the MUX pod, and the LMRP.

20. The computer readable storage device of claim 18, wherein the processor-executable instructions cause the leak detection computer device to:
determine a rate of the leak based on the comparison; and
transmit the rate of the leak to the user.

21. The computer readable storage device of claim 20, wherein the processor-executable instructions cause the leak detection computer device to estimate the impact of the leak on system performance based on the location of the leak and the rate of the leak.

22. The computer readable storage device of claim 17, wherein the processor-executable instructions cause the leak detection computer device to:
derive a difference in closing time for at least one component of the BOP system based on the comparison, where the at least one component includes at least one of a ram and an annular BOP; and
transmit the difference in closing time to the user.

23. The computer readable storage device of claim 17, wherein the processor-executable instructions cause the leak detection computer device to:
determine at least one recommended course of action based on the comparison; and
transmit the at least one recommended course of action to the user.
